(19) United States
(12) Patent Application Publication
(10) Pub. No.: US 2026/0022473 A1
(43) Pub. Date: Jan. 22, 2026

(54) METHOD FOR PRODUCING A MONOMER FROM THE POLYMER COMPRISING THE MONOMER

(71) Applicant: RHEINISCH-WESTFÄLISCHE TECHNISCHE HOCHSCHULE (RWTH) AACHEN, Aachen (DE)

(72) Inventors: Marcel GAUSMANN, Aachen (DE); William GRAF VON WESTARP, Aachen (DE); Jonas GÖRTZ, Aachen (DE); Andreas JUPKE, Leverkusen (DE); Amrei BECKER, Vaals (NL); Thomas GRIES, Aachen (DE)

(73) Assignee: RHEINISCH-WESTFÄLISCHE TECHNISCHE HOCHSCHULE (RWTH) AACHEN, Aachen (DE)

(21) Appl. No.: 18/993,030

(22) PCT Filed: Jul. 12, 2023
(86) PCT No.: PCT/EP2023/069365

§ 371 Date: Jan. 10, 2025

(30) Foreign Application Priority Data
Jul. 14, 2022 (DE) 10 2022 117 657.6
Jul. 14, 2022 (LU) LU502511

(51) Int. Cl. C25B 3/07; C08J 11/14; C25B 3/20; C25B 9/19; C25B 11/042; C25B 15/08

(52) U.S. Cl. CPC C25B 3/07; C08J 11/14; C25B 3/20; C25B 9/19; C25B 11/042; C25B 15/087; C08J 2367/02

(57) ABSTRACT

A process for generating a carboxylic acid from a hydrolysable polymer containing the carboxylic acid includes i) depolymerizing the polymer by hydrolysis in an aqueous hydrolysis solution, to form a carboxylate; ii) optionally removing further monomeric constituents and any further soluble and/or insoluble impurities located in the hydrolysate solution; iii) transferring the hydrolysate solution into an anode compartment of an electrolysis device; iv) performing an electrolysis with the hydrolysate solution in the anode compartment by connecting the electrolysis device to a voltage source, with current flowing through the electrolysis device and ion exchange taking place between the liquids in the anode compartment and the cathode compartment, so that the liquid in the cathode compartment becomes alkaline and protons are formed in the anode compartment that protonate the carboxylate, causing the carboxylic acid to precipitate; and v) removing the carboxylic acid formed from at least part of the hydrolysate solution.

The present invention relates to a process for generating a monomer from the polymer comprising the monomer. The present invention relates more particularly to a process in which a polymer can be regenerated by recovery of the monomer from the polymer, to enable a resource-efficient cycle.

In all fields of industry, sustainable and resource-efficient operation is becoming ever more important. It is therefore of great significance to be able to process a polymer in such a way that its constituents, particularly the monomeric constituents of the polymer, can be regained.

EP 3511451 describes a process for recycling a blended fabric, the process comprising: i) supplying the blended fabric, said fabric comprising cellulosic fibres and synthetic fibres, with the synthetic fibres comprising at least one synthetic plastic, ii) at least partially depleting the synthetic plastic from the cellulose, and iii) further-processing the depleted blended fabric after the depleting. The primary objective of this document is the recovery of cellulose.

WO 2008/028429 A1 describes a process for isolating terephthalic acid from its salt solutions, by passing an aqueous solution of a salt of terephthalic acid into a cathode compartment of a cathode chamber of an electrodialysis device and passing electrolyte into an anode chamber, then subjecting the resulting salt solution and electrolyte solution to an electrolysis, drawing off terephthalic acid—from the reaction of terephthalic acid anions with electrolyte cations in the anode compartment—from the anode compartment, and isolating it from the electrolyte by filtration.

U.S. Pat. No. 4,092,230 describes a terephthalic acid preparation process comprising the electrolysis of an aqueous solution of potassium terephthalate, preferably in the presence of a potassium salt of a stronger acid than terephthalic acid. In a different embodiment of the invention, terephthalonitrile is converted into terephthalic acid by hydrolysing terephthalonitrile in an aqueous medium containing dipotassium terephthalate, potassium bicarbonate and potassium hydroxide, stripping ammonia and carbon dioxide from the hydrolysed product, adding carbon dioxide to the stripped hydrolysis product to precipitate monopotassium terephthalate, electrolysing the monopotassium terephthalate in the presence of a stronger acid than terephthalic acid to precipitate terephthalic acid, and isolating the terephthalic acid product.

U.S. Pat. No. 6,312,582 describes a process for recovering saponification products of alkaline polyterephthalate with soda, wherein both terephthalate ions in acidic form and the sodium ions in soda form are present. In this process, the sodium terephthalate solution formed when the saponification products are dissolved is subjected to an electrochemical pre-acidification to bring the pH to 4 to 7. Thereafter an electrochemical acidification step is performed by electrolysis to precipitate the terephthalic acid in the anode section and obtain the sodium in the cathode section, which can be reused.

EP 2 736 968 B1 describes how in a process and a device for recycling polymeric materials, especially polyesters and polyamides, via a depolymerization process, the reaction for depolymerizing the material under treatment is performed with a solvolytic mixture in at least one microwave depolymerization reactor (6) which extends substantially along an axis (A) and comprises a system (7) for the movement of the reactants, this system enabling continuous operation of the reactor (6); the movement system (7) is an Archimedean screw system which moves the reactants substantially along the axis (A) through the reactor (6).

U.S. Pat. No. 8,298,396 B2 describes processes and devices for producing chemical compounds, especially fermentation products. The invention provides a process for producing one or more chemical substances, the process comprising a fermentation step, in which the substances are formed, and a separation step, which uses at least one electrode pair to induce precipitation of the substances, said pair comprising at least one precipitation electrode and at least one counterelectrode through which an electrical current is passed in order to precipitate the one or more substances.

WO 2020/173961 A1 describes a process for alkaline hydrolysis of one or more plastics polymers to give terephthalic acid (TPA) and/or ethylene glycol (EG) and/or other monomers forming the one or more plastics polymers, where the process comprises a) contacting the one or more plastics polymers with a metal oxide in a solution in the presence of a base, to provide a reaction mixture; b) stirring the reaction mixture for a suitable time under UV light; and c) obtaining terephthalic acid, ethylene glycol and/or the other monomers from the reaction mixture.

The solutions known from the prior art, however, may still have potential for improvement, particularly in terms of the continuous operation of efficient recycling of polyesters, especially of polyethylene terephthalate.

It is therefore the object of the present invention to provide a measure by which at least one disadvantage of the prior art is at least partly overcome. It is an object of the present invention in particular to provide a solution which enables efficient generation of a monomer from a polymer containing the monomer.

The object is achieved in accordance with the invention by a process having the features of claim 1. The object is further achieved by a carboxylic acid having the features of claim 11, by a use having the features of claim 12, by a polymer having the features of claim 13, by a use having the features of claim 14 and by a process having the features of claim 15. Preferred embodiments of the invention are disclosed in the dependent claims, the description and the figures, where further features shown or described in the dependent claims, the description or the figures may—individually or in any desired combination-constitute a subject of the invention unless the context clearly indicates otherwise.

The present invention relates to a process for generating a carboxylic acid from a hydrolysable polymer containing the carboxylic acid, the process having at least the following process steps:
i) depolymerizing the polymer by hydrolysis of the polymer in an aqueous hydrolysis solution, to form a carboxylate and optionally at least one further monomeric constituent of the polymer;
ii) optionally removing further monomeric constituents and any further soluble and/or insoluble impurities located in the hydrolysate solution generated in process step i);
iii) transferring the hydrolysate solution generated in process step ii) into an anode compartment of an electrolysis device;
iv) performing an electrolysis with the hydrolysate solution in the anode compartment, where further to the anode compartment the electrolysis device has a cathode compartment filled with a liquid, by connecting the electrolysis device to a voltage source, with current flowing through the electrolysis device and ion exchange taking place between the liquids in the anode compartment and the cathode compartment, so that the liquid in the cathode compartment becomes alkaline and protons are formed in the anode compartment that protonate the carboxylate, causing the carboxylic acid to precipitate in the anode compartment, for example; and
v) removing the carboxylic acid formed, wherein
vi) liquid arising in a cathode compartment of the electrolysis device in process step iv) is used as a constituent of the hydrolysis solution in step i).

A process of this kind is a particularly advantageous route to recovery of a carboxylic acid, as monomeric constituent of a polymer, so that the acid is amenable, for instance, to renewed polymerization and hence to creation of further value.

The process is therefore employed in particular to recover a carboxylic acid from the polymer comprising the carboxylic acid. As the skilled person will understand, a carboxylic acid also embraces a polycarboxylic acid—that is, for instance, a dicarboxylic or tricarboxylic acid. Additionally, the polymers also embrace homopolymers and copolymers equally.

The process first comprises, according to process step i), the depolymerizing of the polymer by hydrolysis of the polymer in an aqueous hydrolysis solution, to form a carboxylate and optionally at least one further monomeric constituent of the polymer. Correspondingly, the polymer can be present in the aqueous hydrolysis solution and subjected there to hydrolysing depolymerization—that is, can be broken down into its monomeric constituents. The monomeric constituents are preferably in dissolved form in the solution. In principle, the sense of the invention embraces both basic and enzymatic hydrolysis—a basic hydrolysis may be preferable here, as described in greater detail below.

Depending on the hydrolysis process chosen, the hydrolysis solution contains the required constituents, these being, for instance, a base, an enzyme and/or any suitable initiators and/or catalysts.

Whereas for the hydrolysis in general it is the case that the solubility limit of the various products is not to be exceeded, heating the hydrolysis solution to 100° C. and beyond, with lower limits at 130° C. or 140° C. and upper limits at 200° C. or 180° C., for example, or else at temperatures above 200° C. to 300° C., leads to accelerated and more effective conversion of the polymer fraction, more particularly the polyester fraction, into carboxylates, i.e. deprotonated carboxylic acids. Also embraced by the sense of the invention are carboxylates having a plurality of functional groups, such as dicarboxylates, for instance. Similar comments apply in respect of other monomeric constituents, such as alcohols, so that in the case of polyesters, polyols are also included, for instance. This is true analogously for forced mixing of the hydrolysis solution and the polymer, such as the polyester fractions present therein, for instance.

After the at least partial performance of the hydrolysis/depolymerization, the solution is referred to in the invention as hydrolysate solution. This hydrolysate solution generated in process step i) is optionally treated as per process step ii) by the removal of further monomeric constituents—that is, the monomeric constituents which are not the target carboxylic acid—and of any further soluble and/or insoluble impurities located in the hydrolysate solution. In other words, it is possible optionally to remove at least one from the group of any further monomer constituents, any soluble impurities and any soluble impurities that are present. As a result, preferably all or at least a large proportion of the constituents present in the hydrolysate solution in addition to the monomer that is to be recovered can be removed from the hydrolysate solution.

For removal of solids from the hydrolysate solution, it is possible in principle to employ the solids separation techniques known to a skilled person, such as filtration and/or centrifugation.

For example, impurities present may include dyes, which can be removed for instance via adsorption. Activated carbon, for instance, is suitable for this step.

Further monomeric constituents may be removed for example via extraction with a suitable solvent. Where a polyester is used as the polymer, it is possible for example for a polyol, such as ethylene glycol, to be removed from the hydrolysate liquid after the hydrolysis step via distillation, for example rectification, or extraction or a combination of both technologies. The solvent for the extraction can be regenerated and used again. Correspondingly, for example, one or more further monomeric constituents, such as ethylene glycol, can be separated in parallel. The monomeric constituents, such as the ethylene glycol, may be processed again with the acid obtained in the subsequent electrolysis, terephthalic acid for example, to form a polymer, for instance to form PET.

For the extraction of a hydrophilic constituent, such as ethylene glycol, it is possible for example to use an organic solvent which with the ethylene glycol, for example, forms a hydrophobic, eutectic solvent and forms a two-phase system with the aqueous hydrolysate liquid. The extraction may take place in multiple stages. The solvent for example may be menthol or thymol. Since ethylene glycol possesses a lower boiling temperature than the eutectic solvent, rectification of the eutectic solvent allows ethylene glycol to be removed as an overhead product. The solvent obtained in parallel as the bottom product can be resupplied to the extraction procedure after optional further purification, with corresponding processes being possible for other monomeric constituents.

It is noted, however, that the removal of further constituents may be omitted if, for instance, there is only one monomeric constituent of the polymer, and/or if any impurities are removed at a different point. Thus, for example, it is conceivable for monomeric constituents, dyes or other impurities requiring removal to be taken down by electrical events, especially oxidations, at the electrodes of the electrolysis that is described in detail later on.

Non-hydrolysable components, for example those not amenable to alkaline hydrolysis, from the starting material, i.e. from the polymer-containing product, such as aliphatic plastics, cotton, etc., fundamentally remain in the hydrolysate solution as a solids fraction, more particularly in the form of dispersed particles, and can be withdrawn from the system continuously or discontinuously, by filtration or another kind of mechanical removal, for example. Further particles which are not soluble in the hydrolysis liquid, such as adjuvants or impurities in the starting material, can be removed from the system in the same way.

As a result, a largely solids-free hydrolysate liquid with—dissolved therein—polyvalent cations (especially metal ions), obtained carboxylates and other monomeric constituents, such as polyols, remains for the further process steps. The liquid may also include residues, usually in small amounts, of unreacted hydrolysis solution, for example a base, organic residues such as dyes, etc. These residues may be removed from the remaining hydrolysate liquid, as and when required, by suitable known techniques, such as adsorption on activated carbon.

Chromatographic techniques or ion-exchange techniques are likewise known and suitable for the same purpose.

It should be emphasized that the impurities, particularly the organic impurities, are removed from the hydrolysate solution in a condition in which acid is present in ionic form as the carboxylate. This enables selective removal of the frequently non-polar organic impurities from the ionic terephthalates, allowing the carboxylates to remain selectively at least to a large extent in the hydrolysate solution.

After the treatment of the hydrolysate solution according to process step ii), the hydrolysate solution that is generated in process step ii) or, if process step ii) is omitted, is generated correspondingly in an immediately evident way in process step i), is transferred according to process step iii) into the anode compartment of an electrolysis device. The electrolysis device may have the construction known per se in principle and may have an anode compartment with an anode, a cathode compartment with a cathode, and a membrane which separates the anode compartment and the cathode compartment and is permeable in particular to ions. This membrane may be, for example, a cation exchange membrane or a diaphragm. Additionally, in a manner known per se, a voltage source can be connected to the electrolysis device, allowing the electrolysis device to be operated in a manner known per se.

Correspondingly, according to process step iv), an electrolysis is performed with the hydrolysate solution in the anode compartment. The cathode compartment correspondingly is likewise filled with electrolysis liquid. Initially, for example, an aqueous solution with electrochemically inert conductive salt, such as sodium sulfate, potassium sulfate or phosphates, may be present in the cathode compartment. When the electrolysis device is connected to a voltage source, current, more particularly direct current, flows through the electrolysis device. As a result of this, ion exchange takes place between the liquids in the anode compartment and cathode compartment, and so the liquid in the cathode compartment becomes alkaline, through formation of hydroxide ions at the cathode, and protons are formed in the anode compartment and/or at the anode. This causes the pH of the hydrolysate solution in the anode compartment to drop, and the electrolysis can also be referred to as a pH shift electrolysis. Hence it is made possible for the carboxylic acid located in the anode compartment and present in the form of carboxylate to be protonated, and be able to precipitate. In particular, the carboxylic acid precipitates as a solid, which can be removed readily from the anode compartment as a solid in suspension in the liquid. Accordingly, the process may preferably entail generation of such carboxylic acids which precipitate in an aqueous solution.

The generation of terephthalic acid, for example, exploits the finding that this acid in its protonated form has only poor solubility in water (around 9.5*10−5 mol/litre) and correspondingly crystallises in the remaining hydrolysate liquid of the anode compartment and/or is obtained as a solid, for instance a suspension or sediment, which can easily be subsequently withdrawn from the system. Similar comments apply of course in respect of other carboxylic acids having suitable solubilities.

To optimise the electrolysis step, it can be performed preferably at a pH of less than 7, more particularly in the buffer range of the corresponding acid, such as of terephthalic acid. In the latter case, an advantageous pH is from ≥2 to <7, for example from ≥2 to ≤6, for instance from ≥5 to ≤6, and for instance 6. Preference is given to choosing a pH at which the electrode is still electrochemically stable. This can be achieved effectively with the described pH shift electrolysis, allowing the pH in the hydrolysate to be lowered to a level at which the acid is present in fully protonated form. Correspondingly, the crystallization of the acid in the anode region is boosted and transfer of protons into the cathode region of the device is minimized. In principle, however, the pH can be lowered to levels of 2.

For the electrolysis, additionally, a current flow of between 0.1 and 1 A/cm² may be suitable, with a cell voltage of less than or equal to 12 volts.

Accordingly, the carboxylic acid and hence the monomer are present as solids in the hydrolysate solution in the anode compartment and according to process step v) can be removed from at least part of the hydrolysate solution. This may take place again by corresponding solids removal techniques known to the skilled person, such as centrifuging or filtering, for instance. Additionally, the hydrolysate solution may for this purpose be removed from the anode compartment, or the carboxylic acid may be removed from the hydrolysate solution directly in the anode compartment. The carboxylic acid can be subsequently worked up in a desired way.

The purity of the monomers which can be generated in this way, especially carboxylic acids, is easily above 80 mol %. Any remaining impurities can be brought to the desired final purity by redissolving the acid by known methods, for example in a suitable solvent, with subsequent multi-stage crystallization, adsorption and/or by means of chromatographic techniques. Further purification techniques are disclosed in the following Brown-Marquering-Myerson paper: “Purification of terephthalic acid by crystal aging” in Ind. Eng. Chem. Res. 1990, 29, 10, 2089-2093.

For example, the solid acid formed may be removed as a suspension from the anode compartment, by pumping, for instance, and removed continuously or discontinuously via at least one solids removal technique, for example along a bypass which leads away from the anode compartment and has an integrated deposition facility and conduit for returning the residual liquid to the electrolysis device, such as into the cathode compartment, for instance.

Additionally, according to process step vi), liquid arising in a cathode compartment of the electrolysis device in process step iv) is used as a constituent of the hydrolysis solution in step i). In other words, liquid arising in the cathode compartment is conveyed into a hydrolysis volume, in which it may form at least part of the hydrolysis solution.

As a result, the base required for the hydrolysis can be prepared and used in situ in connection with the electrolysis step described. A catalyst used in this context, particularly in the form of soluble metal ions and/or a Lewis acid, especially polyvalent metal ions, can be recovered after the hydrolysis step—in the following electrolysis step, for example. There, by virtue of the flow of electrical current, the metal ions, together with the cations of the base, migrate to the cathode side, where they accumulate in the basic solution. In parallel, during the electrolysis, polyvalent cations pass via the ion-permeable wall or membrane of the electrolysis cell from the anode compartment into the cathode compartment, and form a base with the hydroxide ions produced in the cathode compartment.

In addition, the metal ions may also adhere to the electrode in the form of the metals as a result of electrochemical events, such as electrochemical deposition, for instance, and are released accordingly by a brief reversal of potential in the electrolysis device.

This base and also the metal ions which function as a Lewis acid can be guided subsequently into a facility for performing the first process step (hydrolysis) and hence completely recycled, i.e. routed in a cycle. Suitable metal ions comprise, for example, Zn, Cd, Hg, Cu, Ag, Ni, Pd, Co, Fe, Ti, Be, Mg, Ca, Sr, Al, Sb and Sn, of which in particular Sb, Ti, Zn and Ni may be preferable. It may accordingly be advantageous if the liquid arising in process step iv) and used as a constituent of the hydrolysis solution in step i) comprises a Lewis acid generated by electrical events in the electrolysis or in a process performed for the electrolysis with reversal of potential.

Within the recycling of polymer, therefore, there is additionally recycling of the process base or of the Lewis acid that functions as a catalyst for the hydrolysis. Hence at the same time resources are used efficiently and the energy expenditure, emissions and transport costs are reduced. The utilization of a pH shift electrolysis and hence of the process of the invention decisively reduces or avoids the formation of salt wastes and—in comparison to electrolysis in a chlor-alkali process—the management of gaseous chlorine compounds in the operation. From a technical process standpoint, this base may be obtained particularly advantageously as follows: the removal of the solid acid, particularly terephthalic acid, formed in the anode compartment of the electrolysis results in a liquid arising which can be passed into the cathode compartment of the electrolysis cell. Correspondingly, the liquid arising in process step v) can be passed into the cathode compartment of the electrolysis device. At the same time, cations, especially alkali metal cations or metal cations which migrate from the anode to the cathode compartment during the electrolysis, form an alkaline solution with hydroxide ions which are produced at the cathode during the electrochemical cleavage of water. This alkaline solution contains the electrochemically produced base and also further, catalytically active alkali metal ions and metal ions. This solution may therefore be utilized as described above for the hydrolysis.

The concentration of the Lewis acid in the hydrolysis may preferably be situated in a range of ≤5% by weight, preferably ≥0.5% to ≤2% by weight, for instance ≥1% to ≤2% by weight, more particularly 1% by weight, based on the hydrolysis solution. If the amount of Lewis acid returned from the electrolysis device is not sufficient, further Lewis acid can be added.

The process here is exploiting a particularly advantageous side-effect: in polyester fibres in fabrics, for example, polyvalent cations of these kinds, based for example on zinc (Zn), iron (Fe) or titanium (Ti), are already present. They originate for instance from remnants of the catalyst from the polymerization, from adjuvants in the composite materials or from impurities in the textile material. Such polyvalent cations may optionally also be released into the anolyte by oxidation reactions at the electrode surface or added separately, as salts, for example, in order to establish a desired concentration of the catalyst, relative to the polyester content in the hydrolysis. By virtue of the pH shift electrolysis in the process described here, these catalytically active polyvalent metal ions are held in a largely closed operating cycle.

It is advantageous here to employ the base in a concentration and amount such as to achieve full deprotonation of the carboxylic acid, which is split off during the hydrolysis.

Furthermore, the process described here is particularly advantageous because, in the sense of sustainable operations, it is becoming constantly more important to fulfil high purity of monomers generated for renewed use in the production of a plastic. Accordingly, residue-free removal of the solvents from the plastic is preferred. Such processes have not to date found any relevant application, but in accordance with the invention are readily possible by drying of the acid following its removal, for instance.

The invention is additionally underpinned by the following considerations and findings. Large quantities of polymer-containing composite materials, such as those containing PET, for instance, are available, and have to date been predominantly disposed of—that is, in particular, landfilled or incinerated. Recycling processes disclosed to date are complicated and are often still at an experimental stage. Accordingly, there is an urgent requirement to utilize these composite materials as a raw materials source for the reprocessing of the monomers they contain. Specifically, it would be desirable to produce products recycled from the composite materials, also referred to as “secondary” products, particularly terephthalic acid, and so to preserve primary raw materials sources. The secondary products thus obtained are intended to possess the key product properties of a corresponding product produced on a primary basis, in other words conventionally, so as to be able to provide as far as possible a 1:1 replacement for such primary products.

It has been found that such secondary monomers, for example secondary terephthalic acid, can be obtained from polymer-containing products essentially through a combination of depolymerization by means of hydrolysis and subsequent specific electrolysis of the hydrolysate.

In a first process step, the depolymerization of the polymer, such as of the polyester, polyamide or another polymer containing a carboxylic acid as monomer, via hydrolysis, is used to form a hydrolysate liquid which comprises at least one carboxylate, especially terephthalate, possibly alongside a further monomer constituent.

The process of the invention therefore exhibits advantages that were not realizable in such a way before, as set out below.

Hence substances of value that have to date been mostly landfilled can be put to further value-enhancing use as new products, which saves on resources and reduces the environmental impact in terms of reducing the consumption of primary raw materials, especially fossil raw materials. Because of the free availability, this can be done without being tied to a particular purpose, and so, for example, items of clothing can be transformed into entirely different products. Moreover, the energy consumption and the emissions associated with the generation of new products can be significantly reduced.

It may be preferable for the polymer to comprise a polyester, especially polyethylene terephthalate, with the carboxylic acid formed comprising terephthalic acid in particular. In this regard it is noted that polyester-based fibres are currently used predominantly in textiles. As of 2025, textiles in Europe have to be collected and recycled [EU Strategy for Sustainable and Recyclable Textiles]. In Germany alone, >1 000 000 t of used or surplus textiles are collected on an annual basis. For Europe, for 2025, more than 5 million tonnes of these textiles are expected. Reprocessing of these composite materials in order to obtain individual, pure components therein is therefore a particular advantage. A prominent example among these is polyethylene terephthalate, which, moreover, can be used particularly advantageously through the process of the invention. This is the case, for instance, with regard to the solubility of terephthalic acid in water, which may enable effective precipitation or crystallization in the anode compartment.

With regard to the use of a polyester, as an illustrative application, the polyester-containing starting material, i.e. the polymer-containing product, may for example comprise blends of polyester and fibre that are composed of polyester plastics such as PET, cotton, polyethylene (PE) and/or polypropylene (PP) and optionally further components, and the constituents may be constituents susceptible to alkaline hydrolysis (such as PET) or may form constituents not susceptible to alkaline hydrolysis (such as cotton, PE or PP). As a result, the hydrolysis liquid contains the monomers of the polyester, specifically in the form of at least one polyol and at least one dicarboxylic acid as the corresponding dicarboxylate, in each case in dissolved form.

With the alkaline hydrolysis, these constituents can be advantageously separated and the constituents susceptible to alkaline hydrolysis, terephthalate for example, can be supplied to a subsequent electrolysis, for example a pH shift electrolysis as described above, to then yield corresponding monomers in pure form in further process steps.

It may additionally be preferable for the anode to be designed at least partly with non-stick properties effective for the carboxylic acid produced in step iv). This embodiment may permit significant process-related advantages. Indeed, by preventing the attachment of solids, such as more particularly the carboxylic acid which forms, on the electrode surface, the amount of suspended acid—terephthalic acid, for example—in the anode compartment is increased. Furthermore, there is no interruption to the process for the purpose of removing deposits on the electrodes. The process may therefore be implemented with little servicing and with long-term stability. There are a wide variety of possible ways of generating non-stick properties.

For example, provision may be made for the anode in the presence of the respective anolyte to at least largely suppress attachment of solid terephthalic acid at the electrode, in particular because of electrochemical reactions between electrode and liquid. Specific examples embrace, for example, the anode, at least at its surface, being formed of at least one metal or metal alloy comprising at least one metal from the group consisting of vanadium (V), chromium (Cr), manganese (Mn), iron (Fe), cobalt (Co), nickel (Ni), zirconium (Zr), niobium (Nb) and molybdenum (Mo). The alloy may include at least one, for instance at least two, of the aforesaid metals.

It is advantageous, additionally, that the stated electrodes are less expensive than platinum electrodes typically used. Furthermore, for example, nickel electrodes or electrodes based on an alloy having a nickel fraction, for example >50 mol % of nickel, are at the same time electrochemically stabilized within this process step.

It may additionally be preferable for the hydrolysis performed in process step i) to be a basic hydrolysis. It may be seen as an advantage of a basic hydrolysis, in contrast to an enzymatic hydrolysis, for example, that the hydrolysis accordingly is highly temperature-stable. Despite their advantages, enzymatic hydrolyses can usually only be used below the glass transition temperature of PET (around 80° C.). In the case of a basic hydrolysis, therefore, the crystalline fractions of PET, for example, are accessible in an improved way, since the alkaline hydrolysis can also be performed above the glass transition temperature of the polyester.

A further advantage which has emerged is that no organic auxiliaries are required, as is often the case with other hydrolysis processes. The polyester fraction, for example, can therefore be converted more rapidly into carboxylate and polyols, and the process in this embodiment is therefore more effective. This may be additionally boosted, in the case of using an alkaline hydrolysis, especially with an aqueous hydrolysis solution, by being able to neutralize the resultant carboxylic acid in the presence of a base and so withdraw it irreversibly from the reaction equilibrium.

It may additionally be preferable for the process to be performed continuously. A particular advantage of the process with continuous performance may be seen, for example, as being that in addition to the supplying of the product for recycling and the removal of the acid formed as a secondary product, terephthalic acid for example, the recirculation of the stated base from the electrolysis device into the hydrolysis device and from there to the electrolysis device again can also be implemented continuously. The latter may therefore be advantageous especially when performing a basic hydrolysis.

It may further be preferable for the polymer to be present in the hydrolysis solution in a fraction of ≥0.5 mol/L, based on the hydrolysis solution. The upper limit may be imposed, for instance, by the maximum solubility of the carboxylate formed. Illustrative fractions may be situated, for example, in a range of ≤5 mol/L, for instance at ≥1 mol/L to ≤2 mol/L.

In particular in this embodiment, under the prevailing conditions, the polymer can be hydrolysed effectively, allowing the process to be able to be implemented in a particularly advantageous way, as the solubility limit is usually not exceeded and the polymer is therefore present in dissolved form in the hydrolysis solution.

As already indicated above, there may be particular advantage in the polymer depolymerized in process step i) being a constituent of a product selected from the group consisting of textiles, including clothing, plastic packaging, plastic films and plastic bottles. Products of this kind, to be regarded as substances of value, in particular have been previously disposed of, owing to the complexity of recycling and/or of obtaining the raw materials. In accordance with the invention, however, the advantage is apparent that even products of these kinds which as well as the monomer units include further substances, making onward processing more difficult, can be readily treated by the process of the invention. In other words, the aforesaid products can be characterized as mixed products, which in the invention can be readily treated as starting material, even if they consist only partly of hydrolysable polymers.

Depending on the electrochemical standard potential, the electrolysis may entail reduction of the catalytically active ions and deposition at the cathode. The non-shaping parts of the electrode may be reoxidized by more temporary reversal of potential, combined with a higher through-flow, and so removed from the electrode.

A hydrolysis here can take place in a particularly efficient and time-saving manner if the product is introduced as a comminuted fraction into the hydrolysis liquid. The resultant allows the reaction conditions to be significantly improved.

The above advantages can also be realized, correspondingly, for a carboxylic acid produced by the above-described process. In detail, the carboxylic acid can be produced in an extremely resource-efficient and sustainable manner, as it is recovered from used material or waste substances. Furthermore, the carboxylic acid itself, and also materials used in its preparation, can be circulated, giving even greater emphasis to the advantages described above. A carboxylic acid of this kind can be distinguished from carboxylic acids formed differently, as it may still include traces at least of constituents from the hydrolysis. For example, the carboxylic acid may still include metals or metal ions of the Lewis acids used in the hydrolysis, which may serve as a catalyst in the case of a polymerization that can potentially be performed.

As observed above, it may be particularly advantageous if the carboxylic acid is terephthalic acid, since in this way, in particular, polyethylene terephthalate can be used and constructed in a cycle. This polymer has great potential in particular with regard to reprocessing.

Further described accordingly is the use of the carboxylic acid produced by the process of the invention, especially terephthalic acid, as a monomer for producing a polymer, especially polyethylene terephthalate.

A further subject of the present invention, accordingly, is a polymer, especially polyethylene terephthalate, which is produced from the above-described carboxylic acid, especially terephthalic acid. A polymer of this kind can be distinguished from polymers formed differently, as it may still include traces at least of constituents from the hydrolysis. For example, the polymer may still include metals or metal ions of the Lewis acids used in the hydrolysis, which may serve as a catalyst in the polymerization performed before.

The present invention therefore also relates to the use of a polymer for producing a product, wherein the product is selected from the group consisting of textiles, including clothing, plastic packaging, plastic films and plastic bottles, characterized in that the polymer is a polymer as described above.

It may be particularly advantageous if the monomer generated from a polymer by hydrolysis or depolymerization and electrolysis is converted back into a polymer, which is then converted to a monomer in accordance with the process described above.

In accordance with the above, therefore, a solid acid, especially terephthalic acid, produced according to the process may be utilized as a monomer for production of polymers, such as polyethylene terephthalate (PET), or for production of products composed of these polymers. Any additional purification steps are stated illustratively above. The polymer or polymer-containing product generated may be used as a substitute for a polymer produced from fossil raw materials. The above-disclosed features of the new process for producing terephthalic acid, for example, and also uses thereof can be applied analogously to the production and use of monomers which are chemically comparable to those of terephthalic acid. This includes a process for the secondary production of 2,5-furandicarboxylic acid (FDCA) from a corresponding product (polyethylene furanoate=PEF). Correspondingly, secondary PEF can be produced from ethylene glycol and FDCA recycled accordingly.

Below, the invention is elucidated illustratively with reference to the appended drawings and examples, where the features set out below may represent an aspect of the invention not only each individually but also in combination, and where the invention is not confined to the following drawings, examples the following description and the following working examples.

In the drawings:

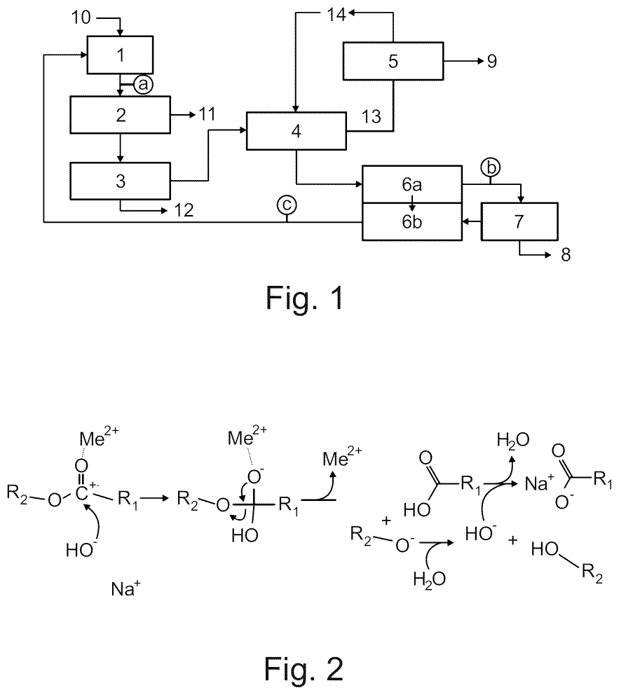

FIG. 1 shows a schematic view of one embodiment of a process according to the present invention;

FIG. 2 shows the general reaction mechanism of the Lewis acid-catalysed alkaline polyester hydrolysis as the hydrolysis of a preferred polymer;

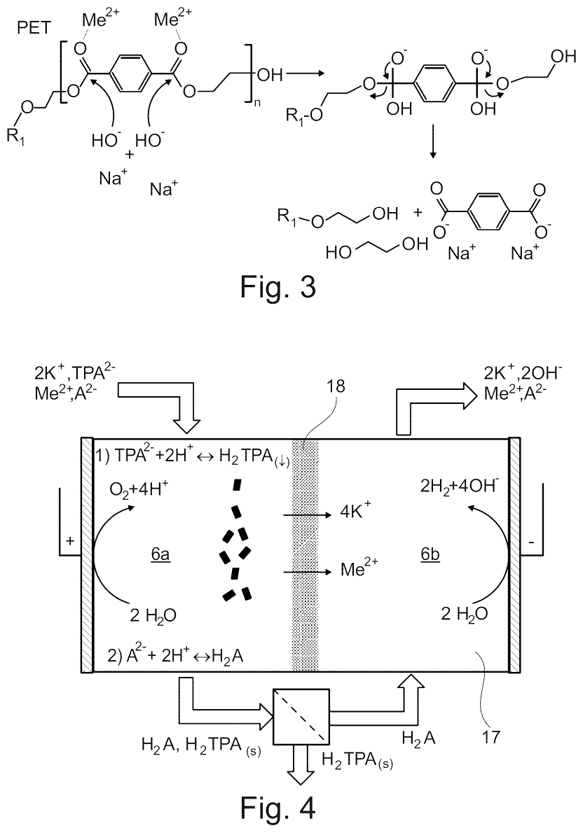

FIG. 3 shows the hydrolysis using the specific example of the basic hydrolysis of polyethylene terephthalate to form ethylene glycol and sodium terephthalate.

FIG. 4 shows an electrolysis cell in which a pH shift electrolysis is proceeding;

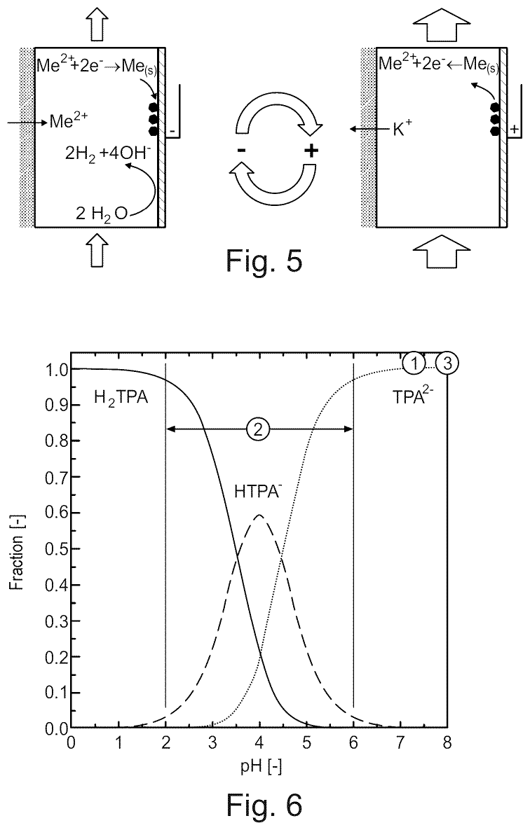

FIG. 5 shows a regeneration of a Lewis acid catalyst as part of one embodiment of the process of the invention;

FIG. 6 shows an illustrative operating range of the pH in the pH shift electrolysis;

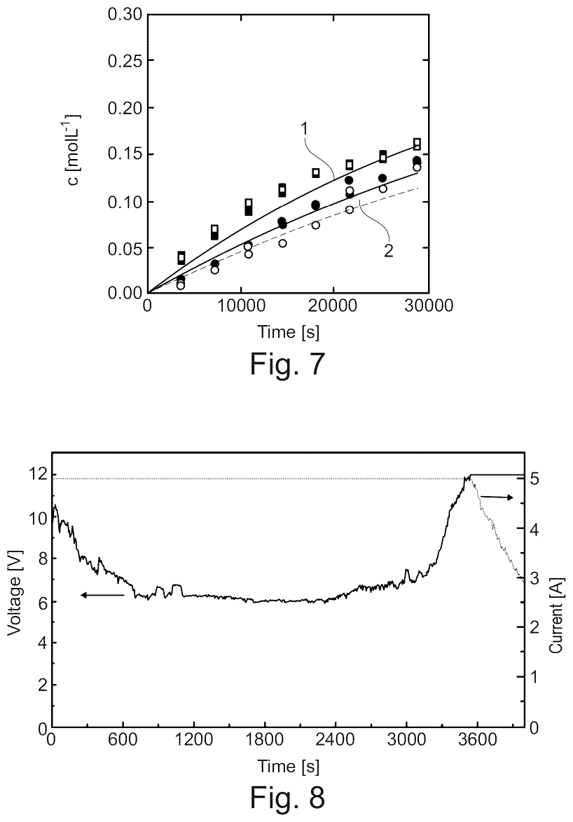

FIG. 7 shows the concentration profile of terephthalic acid during the depolymerization of bottle flakes (1) and fibres (2);

FIG. 8 shows the current and voltage profile of an electrolysis with an Ir anode;

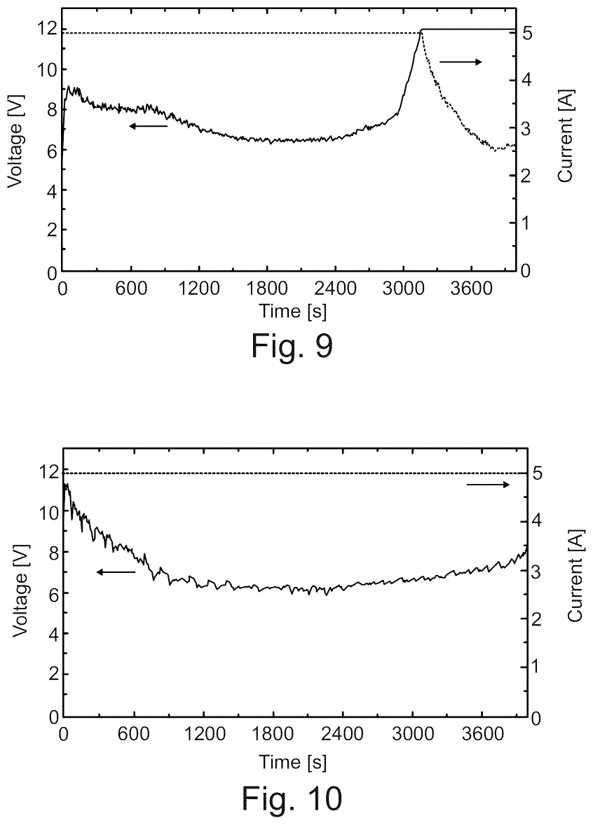

FIG. 9 shows the current and voltage profile of an electrolysis with an Ir anode; and

FIG. 10 shows the current and voltage profile of an electrolysis with an Ni anode.

FIG. 1 shows a schematic representation of an embodiment of a process according to the present invention. A process of this kind is used to generate a carboxylic acid from the polymer comprising the carboxylic acid as a monomeric constituent, the polymer being selectable, for example, from a polyester and a polyamide.

Here, according to reference numeral 10, a polymer-containing product is initially provided, and is selected, for example, from the group consisting of textiles, including clothing, plastic packaging, plastic films and plastic bottles.

According to process step 1, the polymer is initially depolymerized by hydrolysis of the polymer in an aqueous hydrolysis solution, to form a carboxylate and optionally at least one further monomeric constituent of the polymer.

One hydrolysis of this kind is shown as a basic hydrolysis in the scheme of FIGS. 2 and 3. More specifically, FIG. 2 shows the general reaction mechanism of the Lewis acid-catalysed alkaline polyester hydrolysis as the hydrolysis of a preferred polymer, and FIG. 3 shows the hydrolysis using the specific example of the basic hydrolysis of polyethylene terephthalate to form ethylene glycol and sodium terephthalate. Both hydrolyses here are Lewis acid-catalysed.

Returning to FIG. 1, subsequently in process step 2, advantageously, a solids removal takes place to remove solids present in the hydrolysate solution formed in the hydrolysis, allowing the solids-containing impurities as per reference numeral 11 to be carried off. Furthermore, additional constituents, such as additives, may be removed according to process step 3, in the form of removed constituents according to reference numeral 12.

The process step according to reference numeral 4 additionally shows removal of a further monomer, such as a polyol. This may take place in particular via extraction by means of a solvent indissoluble with water. According to reference numeral 13, the monomer, such as the polyol, is carried together with the solvent to a regeneration; reference numeral 5 is intended to show the regeneration. Subsequently, the regenerated monomer can be collected according to reference numeral 9 and the solvent reused according to reference numeral 14.

The carboxylate of the carboxylic acid for generation that is formed in the hydrolysis can be subsequently passed into an electrolysis device, of which reference numeral 6a is intended to show the cathode side and reference numeral 6b the anode side.

FIG. 4 shows a pH shift electrolysis of this kind, with FIG. 4 more precisely showing the electrolysis for obtaining crystalline terephthalic acid by crystallization in the anolyte and cathode-side recovery of base and Lewis acid catalyst.

The liquid in the cathode compartment or cation side 6a of the electrolysis cell 15 of an electrolysis device is preferably alkaline, and this solution may be the hydrolysate solution. Effects below are associated with this as soon as a direct-current voltage has been applied to the electrolysis cell 15 by a voltage source of the electrolysis device, a current is flowing through the electrolysis cell 15, and ions are able to flow through the cation-permeable membrane 18. The circuit is preferably closed by monovalent cations (Li+, Na+, K+), which form a base on the cathode side of the electrolysis cell 15, and by polyvalent metal ions Me²⁺ (Zn2+, Cu2+, Fe3+, etc.), which possess a catalytic activity in the ester cleavage of the alkaline hydrolysis.

Between the two electroconductively connected electrodes (each in an aqueous environment), the water is cleaved electrolytically in accordance with the following reactions:

$$\begin{matrix}in the anode compartment : 2 {H}_{2} O \to 4 {H}^{+} + {O}_{2} + 4 {e}^{-} \\ in the cathode compartment : 2 {H}_{2} O + 4 {e}^{-} \to 4 {OH}^{-} + 2 {H}_{2}\end{matrix}$$

If the circuit within the electrolysis cell 15 is closed neither by protons (H+) nor by hydroxide ions (OH−), but instead predominantly by different ions, such as alkali metal ions or metal ions, the protons produced electrochemically form an acid in the anode compartment (anode chamber) and a base in the cathode compartment (cathode chamber). As a result there is an electrochemically induced pH shift. The formation of an acid in the anode compartment leads to a shift in the dissociation equilibria towards a protonated form. In the case of terephthalic acid, the protonated form of terephthalic acid possesses a lower solubility than hydrogen terephthalate (HTPA⁻) or terephthalate (TPA²⁻), and so terephthalic acid can precipitate as a solid during the electrochemical pH shift. At the same time, a basic solution is generated on the cathode side, since the (alkali) metal ions contained in the terephthalate, as charge carriers, close the circuit in the electrolysis cell 15 and, through the electrodialytic effect, experience a displacement into the cathode compartment. This electrolysis is also called pH swing electrolysis or pH shift electrolysis.

In other words, terephthalic acid may arise—that is, for instance, precipitate or sediment—as a result of crystallization in the anolyte on the anode side (in the anode compartment) of the electrolysis device. Here, the terephthalate obtained in the remaining hydrolysate liquid is converted by electrochemically produced protons into largely completely protonated terephthalic acid. The protonated terephthalic acid crystallizes in the anode compartment and may be drawn off in suspended form from the electrolysis device. In parallel, on the cathode side (in the cathode compartment) of the electrolysis device, a base is formed which may contain polyvalent cations, as elucidated in more detail hereinafter.

In a following process step, the solid terephthalic acid thus formed may be drawn off from the anode compartment of the electrolysis device and treated, for subsequent utilization for further uses. The residual liquid arising in the separation of the solid terephthalic acid may likewise be used again, by being introduced into the cathode compartment of the electrolysis cell. The cations migrating through the membrane in the electrolysis device additionally form the desired alkaline solution in the cathode compartment with the hydroxide ions arising at the cathode during water cleavage, and this solution can be passed back finally into the hydrolysis stage.

FIG. 5 shows in the left-hand diagram how a Lewis acid catalyst may form into a metal during an electrolysis. The right-hand diagram shows that through a reversal of potential, the Lewis acid catalyst can be regenerated and so can be introduced into the process again and, in particular, used again for the hydrolysis.

Returning to FIG. 1, reference numeral 7 then shows the removal of the desired monomer or carboxylic acid, such as terephthalic acid in one preferred example, which can be carried off according to reference numeral 8.

Shown in FIG. 6, additionally, is an advantageous operating range of the pH in the pH shift electrolysis for the example of terephthalic acid. Terephthalic acid possesses two dissociation states. Above a pH of 5, predominantly hydrogen terephthalate and terephthalate are present. By protonation of the hydrogen terephthalate in the vicinity of the anode, crystals of terephthalic acid may be formed at a pH of just 6. Here, the pH shift electrolysis is operated within the buffer range of the terephthalic acid. In FIG. 6, the operating range 2 corresponds to the process status b shown in FIG. 1, the operating range 1 corresponds to the process status a shown in FIG. 1, and the operating range 3 corresponds to the process status c shown in FIG. 1.

The above process provides an alternative, eco-friendly method for the recovery or secondary production of carboxylic acids, such as of terephthalic acid, which is able to provide the principal monomer for production of polymers, such as of PET, without recourse to fossil raw materials and/or without recourse to primary raw materials. At the same time, it is possible thereby to indicate a way of avoiding in particular the landfilling or incineration of polyester-containing products and consequent further burdens on the environment.

### EXAMPLES

### Determining Concentration of the Monomers TPA and EG

The concentration of dissolved terephthalic acid (TPA) and its salts may be determined via HPLC. An Agilent 1200 HPLC fitted with a C18ec column (CS chromatography) and a DAD set to a signal wavelength of 250 nm with 20 nm bandwidth is utilized. The eluent utilized is an isocratic mixture of 50 v % of methanol and 50 v % of an aqueous eluent consisting of 5 v % trifluoroacetic acid, 10 v % methanol and 85 v % water. The measurement takes place at a column temperature of 30° C. and an eluent flow rate of 1 mL/min. Prior to the measurement, samples are diluted 1:500 in the eluent and filtered with a Chromafil Xtra H-PTFE-20/13 syringe filter.

The concentration of ethylene glycol (EG) and short-chain carboxylic acids may be determined via HPLC. An Agilent 1260 HPLC fitted with an Organic acid resin column (CS chromatography) and a DAD set to a signal wavelength of 254 nm, 210 nm and 250 nm with 4 nm bandwidth is utilized. Additionally, a refractive index detector (RI) at 35° C. is used to detect non-UV-active components. The eluent used is an aqueous solution with 2.5 mM H2SO4. The measurement takes place at a column temperature of 30° C. and an eluent flow rate of 1 mL/min. Prior to the measurement, the samples are diluted 1:5 in 0.1 M H2SO4 and filtered with a Chromafil Xtra H-PTFE-20/13 syringe filter.

### Example 1

### Hydrolysis of PET Bottle Flakes

In preparation, clear PET bottle flakes were cryogenically milled in a Retsch ZM 200 with 1 mm impact sieve, to give a starting material having a particle diameter <2 mm for the hydrolysis. 0.5 L of an alkaline hydrolysis solution is filled into a 1 L conical flask. 20.83 g of ground PET are added, so that the final concentration attained is 0.3 M, based on the aqueous solution. Additionally, 0.43 g of ZnSO₄*7H₂O as catalyst is added, to give a cat:PET ratio of 1:100 in the hydrolyte. The reaction solution is boiled under reflux at ambient pressure on a magnetic stirring plate at 300 rpm for the desired time. After cooling to room temperature, solids are removed by filtration using a quantitative filter paper with a particle retention of 2.7 micrometres, to give a clear hydrolysate. With a base concentration of 0.75 M, after 8 h, a conversion of 52.2%±1.2% and with 2 M of 88.6%±0.7% is achieved, based on the amount of PET initially used.

### Example 2

### Hydrolysis of Solids-Containing Production Wastes

PET granules with a TiO₂ content of 0.3 w % are ground as described in Example 1. A 0.75 M NaOH solution is utilized for the hydrolysis. The other reaction conditions are chosen analogously to Example 1. After a reaction time of 8 h, the conversion is 48.05%±0.15%, based on the amount of PET initially used. Filtration yields a hydrolysate which is apparently clear, while a white solid is retained in the filter.

### Example 3

### Hydrolysis of PET-Containing Fibres

20.83 g of PET-containing fibres from used textiles are weighed out. The fibres are placed into the reaction vessel without further pre-treatment. A 0.75 M NaOH solution is utilized for the hydrolysis. The other reaction conditions are chosen analogously to Example 1. The reaction vessel is initially filled with fibres only to the extent such that thorough mixing is still ensured.

The remaining fibres are then added successively in the course of the experiment, as the fibre volume in the reaction vessel goes down.

In this regard, FIG. 7 shows concentration profiles for terephthalic acid in the depolymerization of bottle flakes (1) and fibres (2). In this figure, the dots are measurement values and the lines are calculated concentration profiles, with black and white dots/boxes indicating dual experiments in each case.

### Example 4

pH Shift Electrolysis with Conventional Electrodes

The anolyte utilized is a hydrolysate as described for Example 1. The catholyte introduced at the start is a 0.1 M Na₂SO₄ solution. A two-chamber electrolysis cell with an active electrode area of 100 cm² is utilized. The anode utilized is an iridium-coated titanium electrode from Electrocell and a nickel electrode is utilized as the cathode. For separating the electrolyte chambers, a fumasep F-14100 cation exchange membrane from Fumatech BWT is used. A voltage is applied to establish a constant current flow of 5 A. The electrolysis is carried out until a suspension of solids is formed in the anolyte and the limiting value of 12 V is reached for the cell voltage.

FIG. 8 describes the pH shift electrolysis of the hydrolysate of flakes from PET bottles with an Ir anode. After 3600 s, a marked rise in voltage and drop in the current are apparent. This is due to the formation of a solid layer of terephthalic acid at the anode.

### Example 5

pH Shift Electrolysis with Conventional Electrodes

The anolyte utilized is a hydrolysate as described for Example 2. The catholyte introduced at the start is a 0.1 M Na₂SO₄ solution. A two-chamber electrolysis cell with an active electrode area of 100 cm² is utilized. The anode utilized is an iridium-coated titanium electrode from Electrocell and a nickel electrode is utilized as the cathode. For separating the electrolyte chambers, a fumasep F-14100 cation exchange membrane from Fumatech BWT is used. A voltage is applied to establish a constant current flow of 5 A. The electrolysis is carried out until a suspension of solids is formed in the anolyte and the limiting value of 12 V is reached for the cell voltage.

FIG. 9 describes the pH shift electrolysis of the fibre hydrolysate with an Ir anode. After 3300 s, a marked rise in voltage and drop in the current are apparent. This is due to the formation of a solid layer of terephthalic acid at the anode.

### Example 6

pH Shift Electrolysis with Conventional Electrodes

The anolyte utilized is a hydrolysate as described for Example 1. The catholyte introduced at the start is a 0.1 M Na₂SO₄ solution. A two-chamber electrolysis cell with an active electrode area of 100 cm² is utilized. A nickel electrode is utilized for each of the anode and cathode. For separating the electrolyte chambers, a fumasep F-14100 cation exchange membrane from Fumatech BWT is used. A voltage is applied to establish a constant current flow of 5 A. The electrolysis is carried out until a suspension of solids is formed in the anolyte and the limiting value of 12 V is reached for the cell voltage. It is clearly evident that, in contrast to the examples stated above, a longer operating time without drop in the current is possible.

FIG. 10 shows the pH shift electrolysis of the fibre hydrolysate with an Ni anode. The drop in the current does not occur, since the formation of the covering layer is suppressed and/or since accumulation of terephthalic acid at the anode is prevented.

1. A method for generating a carboxylic acid from a hydrolysable polymer containing the carboxylic acid, comprising:
i) depolymerizing the polymer by hydrolysis of the polymer in an aqueous hydrolysis solution, to form a carboxylate;
ii) removing any soluble and/or insoluble impurities located in the hydrolysate solution generated in process step i);
iii) transferring the hydrolysate solution generated in process step ii) into an anode compartment of an electrolysis device;
iv) performing an electrolysis with the hydrolysate solution in the anode chamber, where further to the anode compartment the electrolysis device has a cathode compartment filled with a liquid, by connecting the electrolysis device to a voltage source, with current flowing through the electrolysis device and ion exchange taking place between the liquids in the anode compartment and the cathode compartment, so that the liquid in the cathode compartment becomes alkaline and protons are formed in the anode compartment that protonate the carboxylate, causing the carboxylic acid to precipitate; and
v) removing the carboxylic acid formed from at least part of the hydrolysate solution, wherein
vi) liquid arising in the cathode compartment of the electrolysis device in process step iv) is used as a constituent of the hydrolysis solution in step i).

2. The method according to claim 1, wherein the polymer comprises a polyester, more particularly polyethylene terephthalate, more particularly wherein the carboxylic acid formed comprises terephthalic acid.

3. The method according to claim 1, wherein the anode is embodied at least partly with non-stick properties effective with regard to the carboxylic acid formed in step iv).

4. The method according to claim 1, wherein the anode, at least at its surface, is formed of at least one metal or metal alloy comprising at least one metal from the group consisting of vanadium, chromium, manganese, iron, cobalt, nickel, zirconium, niobium, molybdenum, zinc and antimony.

5. The method according to claim 1, wherein liquid arising in process step v) is passed into the cathode compartment of the electrolysis device.

6. The method according to claim 1, wherein the hydrolysis performed in process step i) is a basic hydrolysis.

7. The method according to claim 6, wherein the liquid arising in process step iv) and used as a constituent of the hydrolysis solution in step i) comprises a Lewis acid generated by electrical events in the electrolysis or in a process performed for the electrolysis with reversal of potential.

8. The method according to claim 1, wherein the polymer is present in the hydrolysis solution in a fraction of ≥0.5 mol/L, based on the hydrolysis solution.

9. The method according to claim 1, wherein the pH in the anode compartment in process step v) is from ≥2 to <7.

10. The method according to claim 1, wherein the polymer depolymerized in process step i) is part of a product selected from the group consisting of textiles, including clothing, plastic packaging, plastic films and plastic bottles.

11. A carboxylic acid produced by a process for generating the carboxylic acid from a hydrolysable polymer containing the carboxylic acid, the process comprising:
i) depolymerizing the polymer by hydrolysis of the polymer in an aqueous hydrolysis solution, to form a carboxylate;
ii) removing any soluble and/or insoluble impurities located in the hydrolysate solution generated in process step i);
i) transferring the hydrolysate solution generated in process step ii) into an anode compartment of an electrolysis device;
iv) performing an electrolysis with the hydrolysate solution in the anode chamber, where further to the anode compartment the electrolysis device has a cathode compartment filled with a liquid, by connecting the electrolysis device to a voltage source, with current flowing through the electrolysis device and ion exchange taking place between the liquids in the anode compartment and the cathode compartment, so that the liquid in the cathode compartment becomes alkaline and protons are formed in the anode compartment that protonate the carboxylate, causing the carboxylic acid to precipitate; and
v) removing the carboxylic acid formed from at least part of the hydrolysate solution, wherein
vi) liquid arising in the cathode compartment of the electrolysis device in process step iv) is used as a constituent of the hydrolysis solution in step i).

12. (canceled)

13. A polymer produced from a carboxylic acid, the carboxylic acid generated by a process for generating a carboxylic acid from a hydrolysable polymer containing the carboxylic acid, the process comprising:
i) depolymerizing the polymer by hydrolysis of the polymer in an aqueous hydrolysis solution, to form a carboxylate;
ii) removing any soluble and/or insoluble impurities located in the hydrolysate solution generated in process step i);
iii) transferring the hydrolysate solution generated in process step ii) into an anode compartment of an electrolysis device;
iv) performing an electrolysis with the hydrolysate solution in the anode chamber, where further to the anode compartment the electrolysis device has a cathode compartment filled with a liquid, by connecting the electrolysis device to a voltage source, with current flowing through the electrolysis device and ion exchange taking place between the liquids in the anode compartment and the cathode compartment, so that the liquid in the cathode compartment becomes alkaline and protons are formed in the anode compartment that protonate the carboxylate, causing the carboxylic acid to precipitate; and
v) removing the carboxylic acid formed from at least part of the hydrolysate solution, wherein
vi) liquid arising in the cathode compartment of the electrolysis device in process step iv) is used as a constituent of the hydrolysis solution in step i).

14. (canceled)

15. (canceled)

16. The method according to claim 1, wherein
the depolymerizing the polymer by hydrolysis of the polymer in the aqueous hydrolysis solution of step i) forms the carboxylate and one or more further monomeric constituents of the polymer; and
the removing of step ii) includes removing the one or more further monomeric constituents generated in step i).
